(19) United States
(12) Patent Application Publication
(10) Pub. No.: US 2005/0132898 A1
(43) Pub. Date: Jun. 23, 2005

(54) Methods and devices for basting food

(76) Inventor: Andrew Kahler, Fortson, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/740,724

(22) Filed: Dec. 19, 2003

(51) Int. Cl. A47J 37/10

(52) U.S. Cl. 99/345

(57) ABSTRACT

Basting devices for applying liquids and pastes to the surface of food items are provided. One such basting device includes an applicator having a plurality of interlocking chain elements used to apply a variety of basting fluids. Such a device may include a handle attached to the applicator which enables manual application of basting fluids to the food item. Alternatively, the device may be integrated into an automated system in which food items are passed through a curtain of chain elements, a portion of which may be suspended in basting fluid.

### FIELD OF THE INVENTION

The present invention relates to methods and devices for basting food, and more specifically, to basting devices that include chain elements for applying basting fluids to food items.

### BACKGROUND

When cooking meats and similar food items, it is beneficial to intermittently apply basting fluids, such as sauces, marinades or other condiments to the meat in order to enhance the flavor and keep the food juicy and moist. For example, when cooking meat on a barbecue grill, it is common to pour or brush barbecue sauce onto the meat. Likewise, when cooking a turkey in an oven, it is common to periodically baste the turkey with the juices and liquids that collect in the bottom of the roasting pan. Preferably, the basting fluid should be evenly distributed over the exterior surface of the food item to keep it moist and flavorful.

Basting is typically performed with a brush using applicator elements with straight, synthetic, or natural fibers such as the bristles on a paint brush. Alternatively, a food item may be basted with a basting mop. As is known, a basting mop includes applicator elements which may be constructed of cotton braids, fabric mesh, or a cluster of fabric strips. However, both the described basting mop and the basting brush suffer from several disadvantages. The stiff fibers of a basting brush may be harsh on the skin or outer surface of the food being prepared. In some cases, a brush is not desirable because the bristles would penetrate or damage the outer surface of the food when pressing the basting brush against the food item. Additionally, most basting brushes tend to apply an uneven coat of basting fluid to a food item. Instead of an even coat, basting brushes push a bead of basting fluid to each side of the brush, leaving behind streaks of basting fluid on the food item.

Additionally, because the applicator elements of basting brushes and mops are porous, they tend to absorb basting fluids and maintain the basting fluid within the applicator elements rather than applying the basting fluid to the food item. Since the applicator elements of basting brushes and mops absorb the basting fluid, they also tend to harbor bacteria. That is, over time, the applicator elements of basting brushes often become contaminated with food and grease residue which may become trapped within the bristles or applicator material, and decompose. Microbial organisms which thrive on food and grease residue may be inadvertently transferred to meats and other food during further use of the basting brush or mop.

Because food and grease residue tend to become lodged within the bristles of a basting brush, typical washing procedures do not adequately clean the brush. Additionally, only after a few uses, basting brushes and mops become as aesthetically unappealing as they are hygienically unappealing. For instance, tomato or mustard based sauces often discolor the applicator elements of brushes and mops. The bristles of basting brushes also tend to fall out or break onto food items.

Fabric mops and basting brushes are not constructed to withstand multiple uses under harsh cooking conditions, namely high heat. Animal hair, cotton, synthetic fibers, and nylon mesh may catch fire and destroy the brush or mop. Thus, under normal use, basting brushes and fabric mops tend to burn, tear, or disintegrate very quickly.

### SUMMARY

Methods and devices for basting foods are provided. One embodiment of a device for basting the surface of food includes a handle and an applicator attached to the fastening portion of the handle. The handle includes a gripping portion and a fastening portion, and the applicator includes a chain element comprising a plurality of interlocking links. The applicator may further include a retainer connected to the fastening portion of the handle and securing the chain element to the fastening portion of the handle.

Another embodiment includes a plurality of chain elements which are further comprised of a plurality of interlocking links. The device also includes a means for attaching a portion of each of the plurality of chain elements to form a curtain of closely-spaced, suspended chain elements.

An embodiment of a method for applying a basting fluid to a food item includes the steps of: suspending a curtain comprising a plurality of closely-spaced chain elements above the basting fluid such that a portion of the chain elements extend into the basting fluid; and passing a food item through the curtain.

Another exemplary basting method includes the steps of: suspending a curtain comprising a plurality of closely-spaced chain elements above the basting fluid; lowering the plurality of closely-spaced chain elements into the basting fluid; and raising the plurality of closely-spaced chain elements.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 depicts a perspective view of an embodiment of a basting device that uses a single row of chain elements.

FIG. 2 is a perspective view of an exemplary basting device using a circular pattern of chain elements and a handle that is detachably attached to an applicator.

FIG. 3A is a plan view of an exemplary basting device in which each chain element is fastened to the retainer at one of the two ends of each chain element.

FIG. 3B is a plan view of an exemplary basting device in which a central portion of each chain element is fastened to the retainer.

FIG. 3C is a plan view of an exemplary basting device using chain elements having both ends fastened to the retainer and leaving an exposed, loose central portion.

FIG. 3D is a plan view of an exemplary basting device in which each chain element includes a central portion fastened to the retainer at a plurality of connection points.

FIG. 4 is a perspective view of another exemplary basting device including two-rows of chain elements that vary in length.

FIG. 5 is a perspective view of an embodiment of a rotisserie style cooking apparatus using an exemplary basting device.

### DETAILED DESCRIPTION

As will be described in detail here, embodiments of a basting device can be useful for applying basting fluids to food items. Specifically, such a basting device uses an applicator including at least one chain element which directly applies the basting fluid to the food item. As used herein, “basting fluids” include barbecue sauce, condiments, or other liquefied sauces, as well as any type of liquid or paste that may be applied to food. For example, embodiments of a basting device may also be used to apply chocolate, caramel, or butterscotch toppings to a food item.

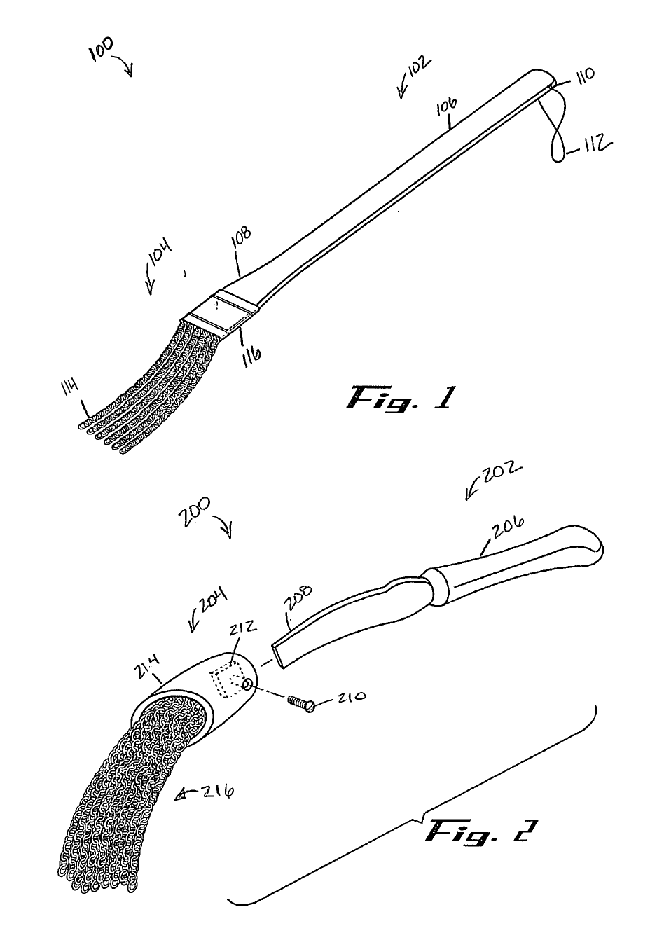

Referring now to FIG. 1, an embodiment of a basting device is presented as chain baster 100. Chain baster 100 generally comprises a handle 102 and an applicator 104. Handle 102 includes both a gripping portion 106 for holding the handle, and a fastening portion 108 for attaching the handle to the applicator. Gripping portion 106 is generally shaped and sized to conform to the hand of a user. Fastening portion 108 is simply the portion of the handle closest to the applicator 104. Handle 102 includes a hole 110 from which a tether 112 is tied. Tether 112 can be used to hang chain baster 100. Applicator 104 is attached to fastening portion 108 and includes at least one chain element 114 which is comprised of a plurality of interlocking links. Additionally, applicator 104 includes a retainer 116 for securing chain element 114 to the fastening portion 108 of the handle 102.

In some embodiments, chain element 114 is attached to retainer 116 with an eye screw. Specifically, one link of the chain element is attached to the eye of the eye screw, and the eye screw is screwed into the retainer portion of the applicator, thereby fastening the chain element 114 to the retainer 116. However, chain element 114 may be secured in retainer 116 or directly to handle 108 by any number of well known methods such as adhesive, screws, bolts, nails, or by crimping.

While applicator 104 of chain baster 100 is depicted as having both an applicator and a chain element, it should be understood that retainer 116 is not always necessary. For example, handle 102 may be constructed of plastic and may be molded around chain element 114, leaving chain element 114 embedded within handle 102. Likewise, a chain element of applicator 104 may be fastened directly to fastening portion 108 of handle 102. For example, chain element 114 may be glued directly to handle 102. Additionally, other embodiments may include a chain element incorporating a first portion that is used to grip the chain element, and a second portion that is used to apply the basting fluid. Thus, in some embodiments, the chain element functions both as the handle and the applicator.

Handle 100 may be constructed of a number of various materials. Such materials may include wood, plastic, or metal. Preferably the gripping portion of the handle is constructed of a material to insulate the hand of a user from heat that may be transferred from a heat source when cooking.

Chain element 114 includes a plurality of interlocking links connected to, or fitted into, one another. For example, the plurality of links may be a traditional interconnected, interlocking ring-type chain, as shown in FIG. 1, or may be a pull-chain type chain such as those commonly used as a pull cord mechanism to operate the internal switch of a light socket. As is known, the pull-chain type chain is comprised of a flexible string of interconnected, interlocking balls. Thus, the plurality of interlocking links of a chain element may be the flexible string of interlocking balls, or may be the traditional string of interconnected rings, for example.

In some embodiments, the links of chain element 114 are constructed of non-absorbent, non-porous, and nonflammable material such as stainless steel or other metals. While it is preferable to use a link material that is non-flammable and durable under high heat, this characteristic is not required since chain baster 100 may be used to apply basting fluids before or after food is removed from a grill or oven. Thus, a variety of other materials, such as plastic, may be used.

Additionally, the size of the links of chain element 114 may vary depending on the physical properties of the basting fluid. For example, when basting a relatively thick sauce, the selected links may be larger because the sauce is more viscous. More basting fluid will be retained by the larger rings of the interlocking links of a ring-type chain when the basting fluid is viscous. Additionally, more basting fluid will adhere to the larger surface area of larger pull-type chain links, or stay trapped between consecutively positioned chain elements when the fluid is viscous. Once the chain element is draped over a food item, the chain elements spread apart leaving a deposit of basting fluid on the surface of the food item. In contrast, if basting with thinner fluids such as broth, for example, the selected link sizes are preferably smaller. By using chain elements of smaller size, the low-viscosity basting fluid is retained within the smaller rings of the interlocking links of a ring-type chain. Additionally, when the basting fluid is less viscous more basting fluid will adhere to smaller pull-chain type chain links, or stay trapped between consecutively positioned chain elements if the links are of a smaller size.

While chain baster 100 depicts chain element 114 having links of uniform size, chain element 114 may be comprised of mixed link sizes in order to adequately baste fluids of different viscosity with the same chain baster. Alternatively, a plurality of chain elements each having different sizes may be attached on the same chain baster to achieve similar benefits.

In practice, a user of chain baster 100 may hold the handle 102 by gripping portion 106. Chain element 114 may be dipped into a basting fluid, which may be in a container or in the bottom of a drip pan, to coat the exposed portion of the chain element 114 with basting fluid. After coating the exposed portion of the chain element with basting fluid, the user may then position chain baster 100 such that applicator 104 is suspended over the food item and chain element 114 is draped over the surface of the food item. A user may then drag chain element 114 across the surface of the food item to evenly apply the basting fluid. The steps may be repeated until the basting fluid is applied to the entire surface of the food item.

Alternatively, instead of dipping the chain element into a container of basting fluid, a user may simply apply the basting fluid from a container, such as a barbecue sauce container, directly on the food item. Once the basting fluid is on the food item, chain baster 100 may be used to evenly apply the basting fluid to the food item as described above.

One potential advantage of an embodiment using chain elements over prior art applicator elements is that the weight of the chain elements naturally apply an even coat of basting fluid without damaging the surface of the food item. The chain elements, particularly after being dipped into the basting fluid, are relatively heavy compared to the elements of brushes or mops. As such, the chain elements tend to more easily drape themselves over food items and achieve even coverage with very little effort from the user. Because a user does not press the elements onto the food item, as is done with brushes and mops, the surface of the item is not damaged.

A further benefit potentially achieved is the ease of cleaning. The chain baster, being preferably comprised of inert, non-porous, and heat-tolerant material, can be scrubbed vigorously by hand or simply cleaned in an automatic dishwasher or passed through high-temperature sterilizing equipment without damage. Such cleaning methods are typically not possible with prior art devices that are usually of much more delicate construction.

Looking now to FIG. 2, exemplary chain baster 200 includes a configuration of chain elements 216 arranged in concentric circles. Such a configuration may be more advantageous for applying a quantity of basting fluid over a food item by trapping basting fluid between the exposed portion of the chain elements. Chain baster 200 includes a handle 202 and applicator 204. Handle 202 includes gripping portion 206 and fastening portion 208. Handle 202 may be detachable from applicator 204 so that applicator 204 may be separately sanitized and cleaned from the handle. Handle 202 may attach to applicator 204 using any suitable fastener such as a latch or the threaded bolt 210 and receptacle 212 depicted in FIG. 2 such that handle 202 is detachably attached to applicator 204. Applicator 204 includes retainer 214 and chain elements 216 arranged in a circular pattern. While FIG. 2 depicts chain elements 216 arranged in a series of concentric circles, chain baster 200 may alternatively use a number of effective patterns including a single circular pattern, a semi-circular pattern, a rectilinear pattern, etc.

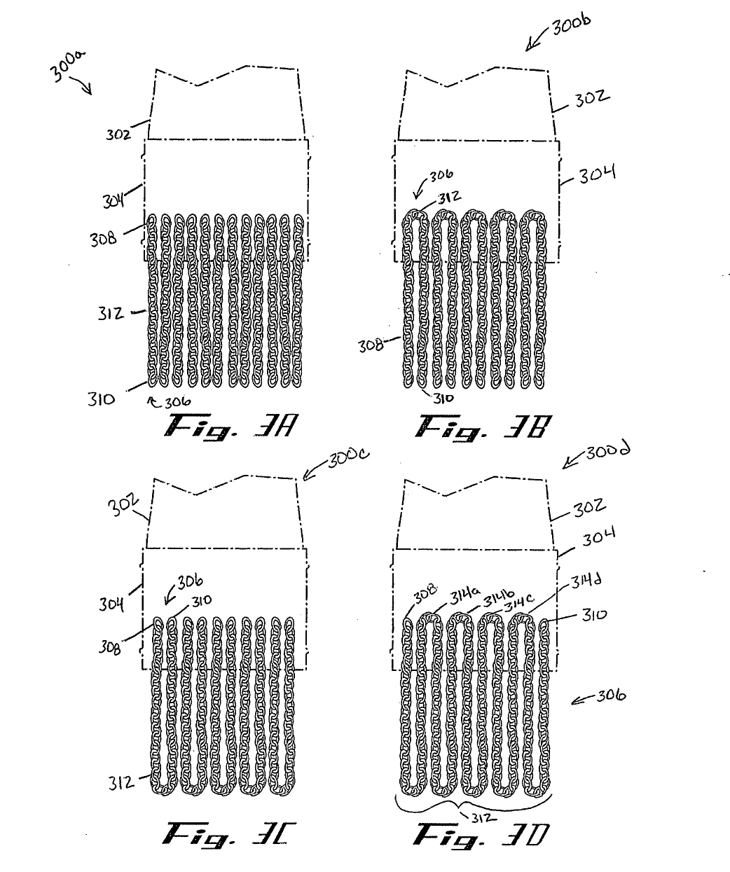

FIGS. 3A-3D depict a series of exemplary attachment configurations which may be used to attach chain elements to the retainer or handle of a chain baster. FIGS. 3A-3D each depict a fastening portion 302 of a handle and an applicator comprising retainer 304 and at least one exemplary chain element 306.

Looking specifically to the exemplary attachment configuration of FIG. 3A, referenced as configuration 300a, exemplary chain element 306 includes a first end 308 and a second end 310, with the first end 308 being fastened to retainer 304. Thus, in the embodiment of FIG. 3A, each chain element is secured on one end by the retainer and the remaining portion is exposed and hangs freely for use in applying basting fluid.

Looking now to the exemplary attachment configuration of FIG. 3B, referenced as configuration 300b, exemplary chain element 306 comprises the first loose end 308, and the second loose end 310, and a central portion 312 which is fastened to retainer 304. The first and second loose ends 308 and 310 are exposed and hang freely for use in applying basting fluid. The central portion 312 is any portion of the chain element 306 not defined as a loose end. While FIG. 3B depicts that loose end 308 and loose end 310 are of substantially equal length, the central portion may be shifted such that the loose ends are unequal in length.

Looking now to the exemplary attachment configuration of FIG. 3C, referenced as configuration 300c, exemplary chain element 306 comprises a first end 308 and a second end 310 fastened to retainer 304. Central portion 312 forms an exposed loop and hangs freely from retainer 304.

Looking now to the exemplary attachment configuration of FIG. 3D, referenced as configuration 300d, exemplary chain element 306 comprises a first end 308, a second end 310, and a central portion 312. Central portion 312 includes each interlocking link except for the link at the first and second end 308 and 310. In this embodiment, central portion 312 is fastened to retainer 304 at a plurality of connection points 314a-314d, forming a plurality of hanging, exposed loops. While the embodiment of FIG. 3D depicts chain element 306 with the first end 308 and the second end 310 fastened to retainer 304, another embodiment may be configured such that the first end 308 and/or the second end 310 may hang freely from retainer 304.

While each of FIGS. 3A-3D depict a distinct exemplary attachment configuration, many variations are possible. For example, a single chain baster may be constructed using any combination of the attachment configurations described above.

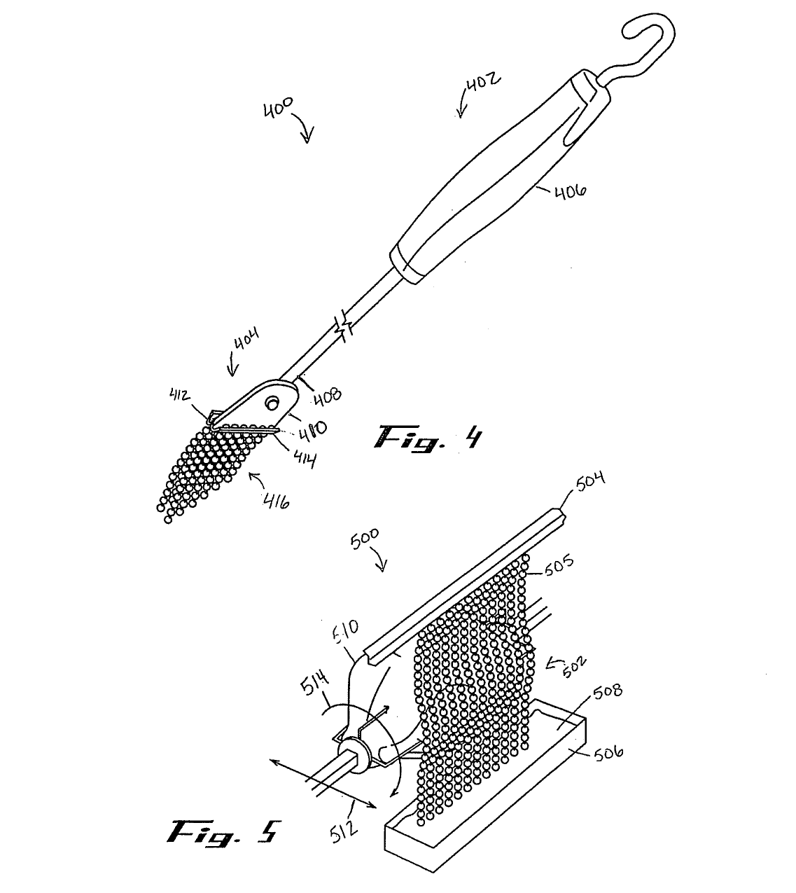

Looking now to FIG. 4, another embodiment, referenced as chain baster 400, includes a double-row configuration of chain elements. Chain baster 400 includes handle 402 and applicator 404. Handle 402 includes gripping portion 406 and fastening portion 408. Applicator 404 includes a retainer 410 attached to the fastening portion 408. Retainer 410 secures a first row 412 and second row 414 of chain elements to fastening portion 408. While FIG. 4 depicts the first and second row of chain elements 412 and 414 as using a pull-chain type chain, a chain using interlocking loops may also be used. It also may be desirable to configure the loose ends 416 of the first and second row of chain elements 412 and 414 with varied lengths. For example, the chain elements in FIG. 4 have been selected and configured such that the loose ends 416 taper from one side to the other.

Looking now to FIG. 5, exemplary chain baster 500 may be implemented as part of an automated system such as a rotisserie cooker. According to this embodiment, a plurality of chain elements 502 are attached to retainer 504 to form a curtain 505 of closely-spaced, suspended chain elements 502. The chain elements 502 may be attached to retainer 504 according to various methods, such as those described previously. The chain elements 502 of chain baster 500 are suspended above a pan 506 of basting fluid 508. A portion of the exposed chain elements 502 extend into basting fluid 508.

In practice, a food item 510 is passed through chain curtain 505 in one of the two directions indicated by arrow 512. Additionally, food item 512 may be rotated, such as in the direction indicated by arrow 514. As food item 510 passes through chain curtain 505, the portion of the chain elements 502 that extend into the basting fluid 508 lift out of the basting fluid and pass over food item 510. As food item 510 passes through the curtain, the basting fluid is applied to the food item. Because chain elements are preferably designed to be heavy enough to sink into basting fluid 508, retainer 504 may be maintained in a stationary position. After food item 508 passes through curtain 505, a portion of the chain elements 502 may extend into the basting fluid once again. This process may then be repeated in the opposite direction. Accordingly, this process may be repeated at predefined time intervals to keep the food item moist and flavorful.

In another embodiment of chain baster 500, retainer 504 is lowered to dip the suspended curtain 505 of chain elements 502 in basting fluid 508, and then raised before passing food item 510 through curtain 505. Thus, according to this embodiment, curtain 505 is dipped into the pan 506 of basting fluid 508 to coat the chain elements 502 with basting fluid. After coating the curtain 505 of chain elements 502 with basting fluid, curtain 505 is raised, at least partially, and the food item is passed through the curtain, applying basting fluid to food item 510. More than one food item 512 may be passed through curtain 505 between subsequent lowering steps.

While the described chain baster embodiments may be used to baste food with a basting fluid, it should be understood that the described embodiments may actually be used to apply a fluid substance (e.g. liquid or paste) of any type to practically any surface. For example, the described chain baster embodiments may be used to apply paint or adhesives to the surface of various objects in a similar manner.

It should be emphasized that many variations and modifications may be made to the above-described embodiments. All such modifications and variations are intended to be included herein within the scope of this disclosure and protected by the following claims.

1. A device for basting the surface of food comprising:
a handle including a gripping portion and a fastening portion; and
an applicator attached to the fastening portion of the handle, including:
a chain element comprising a plurality of interlocking links.

2. The device of claim 1, wherein the applicator further comprises:
a retainer connected to the fastening portion of the handle and securing the chain element to the fastening portion of the handle.

3. The device of claim 1, wherein the handle is detachably attached to the applicator.

4. The device of claim 1, wherein at least two of the plurality of interlocking links are of differing sizes.

5. The device of claim 1, further including a second chain element comprising a second plurality of interlocking links.

6. The device of claim 5, wherein the plurality of interlocking links of the first chain element are constructed of a first predetermined size, and the second plurality of interlocking links of the second chain element are constructed of a second predetermined size different from the first predetermined size.

7. The device of claim 2, wherein the chain element comprises a first end and a second end, the first end being fastened to the retainer.

8. The device of claim 2, wherein the chain element comprises a first end and a second end, the first end and the second end are fastened to the retainer.

9. The device of claim 2, wherein the chain element comprises:
a first loose end and second loose end; and
a central portion including each interlocking link except the link at the first and second loose end, the central portion fastened to the retainer.

10. The device of claim 2, wherein the chain element includes:
a first end and a second end; and
a central portion including each interlocking link except the link at the first and second end, the central portion fastened to the retainer at a plurality of connection points.

11. The device of claim 1, wherein the chain element is constructed of a non-absorbent material.

12. The device of claim 1, wherein the plurality of interlocking links are ring shaped.

13. The device of claim 1, wherein the chain element is selected from a pull-chain type chain and a ring-type chain.

14. The device of claim 1, wherein the applicator further includes:
an exposed portion of the chain element arranged in a pattern selected from a row, a circle, a semi-circle, and a rectilinear pattern.

15. The device of claim 1, wherein the applicator further includes:
an exposed portion of the chain element comprising a plurality of exposed chain elements.

16. The device of claim 15, wherein the plurality of exposed chain elements vary in length.

17. A device for applying a basting fluid to the surface of food, comprising:
a plurality of chain elements comprising a plurality of interlocking links; and
means for attaching a portion of each of the plurality of chain elements to form a curtain of closely-spaced, suspended chain elements.

18. The device of claim 17, further comprising:
a retainer attached to the plurality of chain elements.

19. A method for applying a basting fluid to a food item, the method including the steps of:
suspending a curtain comprising a plurality of closely-spaced chain elements above the basting fluid such that a portion of the chain elements extends into the basting fluid; and
passing the food item through the curtain.

20. The method of claim 19, further comprising
selecting a link size of the chain elements based on the physical properties of the basting fluid.

21. The method of claim 19, further comprising:
maintaining a retainer, from which the curtain of the plurality of closely-spaced chain elements are suspended, in a stationary position.

22. A method for applying a basting fluid to a food item, the method including the steps of:
suspending a curtain comprising a plurality of closely-spaced chain elements above the basting fluid;
lowering the plurality of closely-spaced chain elements into the basting fluid; and
raising the plurality of closely-spaced chain elements.

23. The method of claim 22, further comprising:
passing the food item through the curtain.
